(19) United States
(12) Patent Application Publication
(10) Pub. No.: US 2010/0298026 A1
(43) Pub. Date: Nov. 25, 2010

(54) INTERACTIVE TERMINAL AND ASSOCIATED TERMINAL CONTROL SYSTEM FOR COMMUNICATION AND MEDIA DISTRIBUTION

(75) Inventor: John Goodman, Minnetonka, MN (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: A-VU MEDIA CORP, Minnetonka, MN (US)

(21) Appl. No.: 12/777,869

(22) Filed: May 11, 2010

Related U.S. Application Data
(60) Provisional application No. 61/180,636, filed on May 22, 2009.

(51) Int. Cl. H04M 1/00; H04N 5/225; G06F 3/048

(52) U.S. Cl. 455/552.1; 348/207.11; 715/825; 348/E05.024

(57) ABSTRACT

Media content and communication services are provided to a user. A schedule of media content and communication services provisioned for the user is received, and an interactive menu is generated including selectable options for each of the provisioned media content and communication services. The interactive menu is stored in a host device associated with the user. The interactive menu is displayed on a display connected to the host device, and the host device receives input signals from a remote control that correspond to selections of the selectable options on the interactive menu. The media content or communication service associated with an option on the interactive menu is initiated when selected with the remote control.

### CROSS REFERENCE TO RELATED APPLICATION

This application claims priority to Provisional Application No. 61/180,636, filed May 22, 2009, which is herein incorporated by reference in its entirety.

### TECHNICAL FIELD

The present invention relates to communication and media distribution. More particularly, the present invention relates to a system for providing communication and media access to a user and an approved network via a simplified user interface having remotely definable content and menu options.

### BACKGROUND

Older adults and the disabled represent very large but significantly underserved markets for today's broadband based connections and services. Next generation networks are emerging with significant focus on delivering bundles of voice, video, and data (e.g., Internet) services, but these new bundles of services have not been developed for these populations and their unique needs or capabilities. Historical offerings that required adaptation to new technology or self-provisioning that includes installation and user maintenance of system parameters and settings have not been widely adopted by these user groups. Broadband network operators frequently view these segments as low dollar and high maintenance. The lack of connection and/or access to advanced services creates limits and personal isolation when these technologies could be significant assets to meet the user's unique needs.

Access to healthcare and its related costs are personal, state, and national issues that will reach a crisis stage without a revolutionary transformation. Healthcare is facing a perfect storm of aging demographics, expanding medical technology, expanding coverage, entitlement mentality, and slow growth in traditional and personal resources. One solution involves new delivery models that move into home delivered healthcare that extend independent living, improve health and disease management, reduce inpatient days of care, and reduce the demands on traditional medical resources. Older adults and the disabled represent very high cost segments in the medical system and therefore must be part of the solution. However, their current lack of effective broadband connections creates barriers to implementing new healthcare technology and care options that simultaneously improve outcomes and reduce costs.

### SUMMARY

In one aspect, media content and communication services are provided to a user. A schedule of media content and communication services provisioned for the user is received, and an interactive menu is generated including selectable options for each of the provisioned media content and communication services. The interactive menu is stored in a host device associated with the user. The interactive menu is displayed on a display connected to the host device, and the host device receives input signals from a remote control that correspond to selections of the selectable options on the interactive menu. The media content or communication service associated with an option on the interactive menu is initiated when selected with the remote control.

In another aspect, a system provides media content and communication services to users. The system includes one or more interactive terminals each associated with a user and including a host device, a display, and a remote control. The system also includes a centralized systems portion in communication with each host device of the one or more interactive terminals. The centralized systems portion, which may include a local or network server, receives a schedule of media content and communication services provisioned for each user and generates an interactive menu specific to the user including selectable options for each of the provisioned media content and communication services. The centralized systems portion also provides the interactive menu specific to the user to the host device of the interactive terminal associated with the user. The remote control generates input signals to the host device that correspond to selections of the selectable options on the interactive menu, and the host initiates the media content or communication service associated with an option on the interactive menu selected with the remote control.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of an embodiment of a system for communication and media distribution to one or more interactive terminals.

FIG. 2 is a front view of a remote control suitable for use with the interactive terminals shown in FIG. 1.

FIG. 3 is a screen view of an exemplary first or primary screen providing access to provisioned services available via the interactive terminal including a presentation of remote suitable for use with the interactive terminal.

FIG. 4 is a screen view provided on the interactive terminal for selecting from available television services on the system.

FIG. 5 is a screen view provided on the interactive terminal for selecting from a list of stored video options to watch.

FIG. 6 is a screen view provided on the interactive terminal for selecting from music options on the system.

FIG. 7 is a screen view provided on the interactive terminal when viewing a new downloaded photo.

FIG. 8 is a screen view provided on the interactive terminal for selecting voice and text message services.

FIG. 9 is a screen view provided on the interactive terminal for selecting from a list of activated websites that can be accessed on the system.

FIG. 10 is a screen view provided on the interactive terminal for selecting from phone options available on the system.

FIG. 11 is a screen view provided on the interactive terminal for selecting from medical or community service options available on the system.

### DETAILED DESCRIPTION

The interactive terminal described herein combines a multipurpose digital screen with a highly simplified remote that creates automated use of pre-provisioned access to a wide range of services and connections. This structure creates a level of integration and simplified access that is a tradeoff between the benefits of automated access and user control or flexibility. Simplified access is achieved by taking away user control and flexibility, and automating access to the connections and services a user or their approved network wants to have available on their system. The system also includes the ability of the user or a third party to provide a schedule that provisions and changes the available automated connections and services for the benefit of the primary user and their approved network that benefits from automated access to the user.

Services accessed through the screen and remote include multichannel video programming distributor (MVPD) TV, access to all basic broadband connections, information and services, access to internet supported video conference calls, access to both Voice-over-Internet Protocol (VoIP) and cell phone voice calls, internet hosted video calls, and secure access to a wide range of medical service information and connections. The system structure enables cost effective delivery of medical services on a secure virtual private network (VPN) platform to many parties that would otherwise not be able to have access to them.

The remote provides access to all services via a simple 12 button structure. Buttons are also larger and arranged with enough spacing to facilitate easy use as compared to today's typical 30+button remotes with very tight spacing and small print text to identify their use. The remote is also based on a WiFi or other active wireless connection that eliminates the need for the remote to have a “line-of-sight visual” relationship to the screen to be able to control the system as is required for infrared TV remotes. In other words, this remote not only controls the system when it is not pointed at the screen, but also is capable of controlling the system from a different room.

The telephone may also be a highly simplified handset. In some embodiments, the telephone is a hybrid phone that combines a Voice over Internet Protocol (VoIP) structure in the residence with a cell phone connection whenever the phone is out-of-range of the VoIP connection. This telephone is expected to provide the highest level of connection and security possible for users. If the VoIP connection in the residence fails for any reason, the phone automatically seeks a cell phone connection as a backup. Global positioning system (GPS) plus cell system location technology may be used to provide the highest level of location information. Emergency calls can include interaction with a customer service operator who has approved access to personal customer medical and other information to assist any response team.

The simplified user interface may be coupled with the ability of a customer service agent to remotely control and provision the user's system. In some cases, the customer service agent is available to the user at any time of day. Simplicity for the user is mirrored by increased complexity at the customer service operations.

With today's broadband networks and modifications to existing remote control software, the operator can remotely control all of the services available on the interactive system. Simplified control screens are developed for each element of the system that the customer service operator manages and changes on behalf of a user. This primary operator may be backed up by an advanced technical support group that can remotely control the system dedicated to a user. The operator may also act as a concierge with the ability to direct a user to different broadband sourced information or services that are desired by the user or the user's personal network.

The managed network provided additional operating benefits to hospitals and housing or service management organizations. Hospitals can replace their cable TV networks with broadband video networks that are capable of not only delivering traditional TV, but also support live video connections from any point on the network to any other point. When a patient is admitted to the hospital or other care facility, the unit in their room can be provisioned to support all the personal network connections and access to entertainment that they desire. Nurses, doctors and other hospital staff may also have video, speaker phone, or text access to each patient. Since the connections are pre-programmed, hospital staff may also have automated access to family or external caregivers as may be needed for consultation or the ability to provide care updates. Education and training may be enhanced by providing patient access to a Web based library of accessible video material that can be ordered for the patient to use in the hospital or as follow up after discharge. Communications on the internal broadband network can also automatically update the Electronic Medical Record system and be recorded for billing or liability issues.

Organizations responsible for senior or disabled housing can have similar automated secure access to their managed residences in multi-dwelling units or to remote single housing locations. The secure broadband connections also provide opportunities for cost effective security and monitoring that can improve service and lower cost.

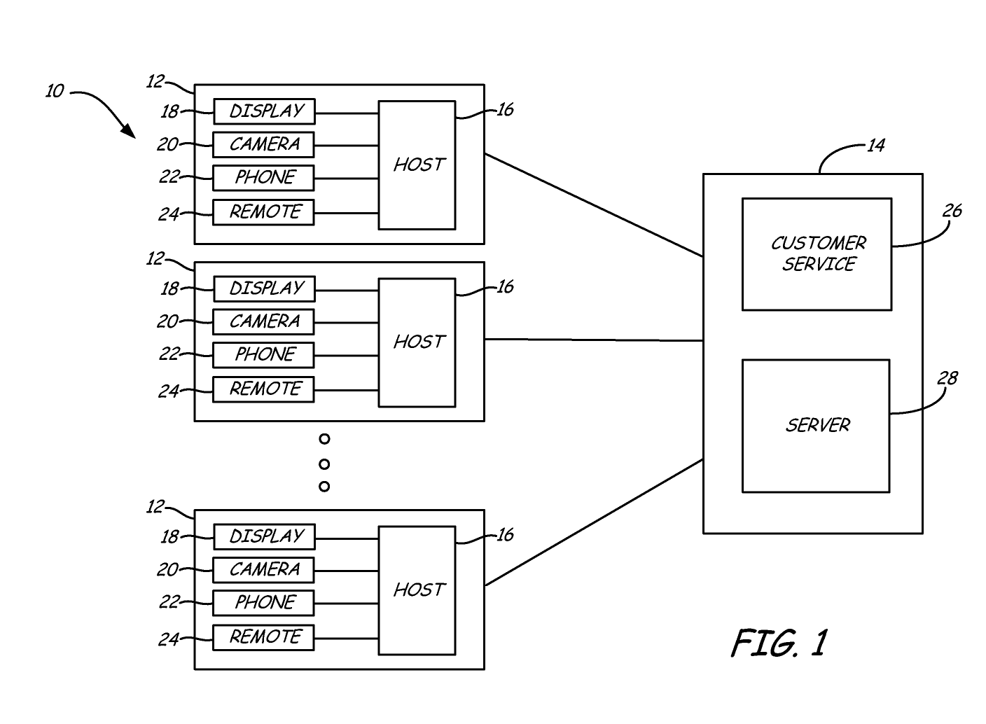

FIG. 1 is a block diagram of a system 10 for communication and media distribution to one or more interactive terminals 12. The interactive terminals 12 communicate with a centralized systems portion 14. While three interactive terminals 12 are shown, the system 10 may include any number of interactive terminals 12 that communicate with the centralized systems portion 14. The interactive terminals 12 each include a host 16, a display 18, a camera 20, a telephone 22, and a remote control 24. In some embodiments, the host 16 communicates with and/or controls operation of the display 18, camera 20, and telephone 22. The host 16 may also coordinate communication of the interactive terminal 12 with the centralized systems portion 14. The remote control 24 may be used to communicate with the host 16 to interact with and control certain operations of the host 16. Signals between the interactive terminals 12 and the centralized systems portion 14 may be routed through a central communications port, or the interactive terminals 12 may each communicate with the centralized systems portion 14 directly.

The centralized systems portion 14 includes a customer service resource 26 and a server 28. The customer service resource 26 and server 28 may be provided at the same or different locations. When in different locations, the customer service resource 26 may be located at a customer center, and the server 28 may be located at the same facility as the interactive terminals or another remote location, for example. As will be described in more detail herein, the customer service resource 26 provides assistance to users of the interactive terminals 12 and works with the users and/or third parties to control menuing and provisioned content and service options for the users. The server 28 may store information and content that is provided to the interactive terminals 12.

The interactive terminals 12 may be provided in a private home, an eldercare facility, the residence of a disabled person, or the patient's room in a healthcare or eldercare facility, for example. The interactive terminal 12 may be connected to a locally or remotely located server 28 or centralized systems portion 14 that provides and controls access to the provisioned services and information. In addition to the components shown, the interactive terminal 12 may include local media players and devices, such as a video player (e.g., DVD or Blu-Ray player) and/or a personal computer, that are provided in the host 16 and accessible through the menuing system on interactive terminal 12. Alternatively, some or all media players and devices may be located at and accessed through the centralized systems portion 14.

The host 16 may be a box-like structure that provides access to and control of multimedia and data services for the interactive terminal 12. Alternatively, the host 16 may be a multimedia personal computer. The host 16 communicates with the centralized systems portion 14 to provide the user with provisioned services and information, and to provide access to the customer service resource 26. The host 16 includes connections or devices to provide connectivity with each of the elements (display 18, camera 20, telephone 22, remote control 24) of the interactive terminal 12 and other external devices (e.g., a computer, portable hard drive, video camera, still camera, etc.). For example, the host 16 may include audio/video connections (e.g., HDMI, DVI, component video, coaxial, etc.), data connections (e.g., Ethernet, USB, FireWire), and/or wireless connections (e.g., radio frequency, infrared) The host 16 may further include an integrated local hard drive to store media (e.g., photos, video, etc.) for the user.

The display 18 may be a television that receives audio and video signals through the host 16. For example, the host 16 may receive signals from a source of cable or satellite television, and provide the signals to the display 18 as an output. In an alternative embodiment, the display 18 is a computer monitor. In some embodiments, the display 18 is configured with any 720p or greater resolution. The display 18 may be a digital television of any size that has inputs for both a PC and TV signal using application software that takes control of the primary user functions and related displays. This display 18 can use a fully integrated multimedia disc player or also be configured with a separate multimedia disc player that can be controlled with the remote control 24 as configured.

The camera 20 may also have video and still image capturing capabilities. In some embodiments, the camera 20 is integrated with the display 18. This provides an interface for video conferencing, for example, wherein the user can communicate via a broadband connection with another party.

The camera 20 used by the video call service is also available for security or other observation of the residence. The camera 20 may have a fixed wide view capability with auto focus. The camera 20 may be positioned to capture video of the user's bed and surrounding areas in the user's in-patient or in-home room, for example. More sophisticated cameras 20 may also be available that pan and scan the user's room. The system may also be capable of hosting additional remote cameras that may be desired for security, user (e.g., patient) monitoring, or resident management. These cameras may also be capable of remote activation.

Normal control for the camera 20 to be available and active or turned off is provided to the primary user of the interactive terminal 12. The camera 20 may also be capable of remote activation where remote activation has been legally approved by the user under certain circumstances. For example, the camera 20 may be remotely activated by a nurse to check on the status of the user, if the user has approved such monitoring. Activation may also be approved for customer service or for members of the user's network that communicate with or provide service to the user.

The audio and video produced by the camera 20 may be recorded if desired for future reference.

The telephone 22 associated with the interactive terminal 12 may be a hybrid phone that combines the use of VoIP connections in the residence location and cell phone connections whenever the hand set is out of range of the residential base station. This telephone 22 may include a simplified keypad similar to the twelve button remote control 24. The telephone 22 may provide direct access to a customer service operator at the customer service resource 26.

When any phone call is received by the system 10, a record of that call may be stored in the system 10, and a caller identification message is also sent to the display 18 so the user can determine if he or she wants to answer the call or not. The same preprogrammed speaker phone connections that are available through the screen speaker phone system (described herein with regard to FIG. 8) may automatically be available as auto dial numbers on the telephone 22. In addition, recorded voicemail messages available through display 18 (described herein with regard to FIG. 6) may also be retrieved using the telephone 22.

Since the telephone 22 is both cell phone and VoIP capable, the cell phone connection becomes the emergency backup link if the VoIP connection fails for any reason. The telephone 22 may also host GPS location technology that relays location to the customer service operations. The combination of GPS technology, VoIP technology that verifies if someone is home, and cellular location technology creates an environment for emergency response that provides a high level of location information. Broadband technology also provides remote access for a customer service operator to control any settings on the telephone 22.

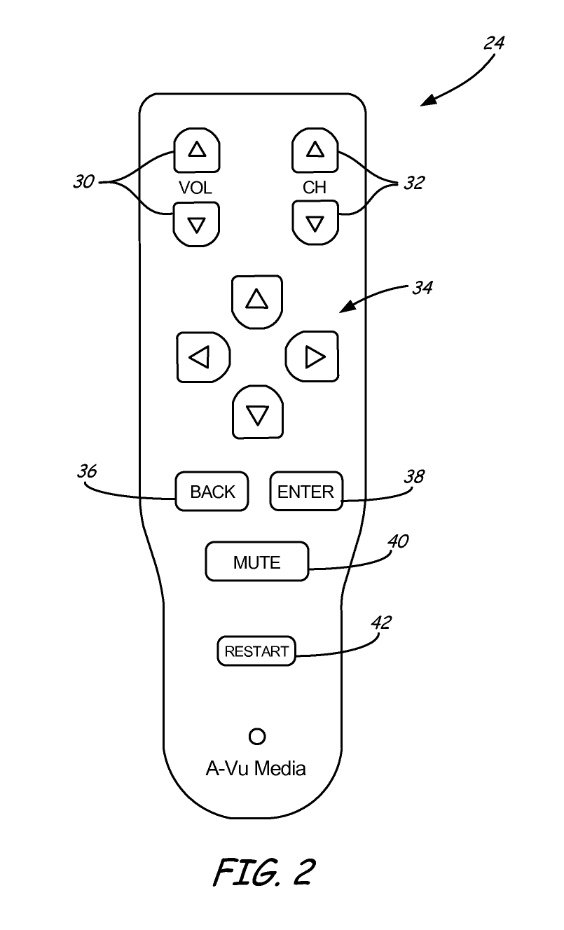

The remote control 24 provides system navigation and service activation for all remotely managed services in the interactive terminal 12. The remote control 24 may be based on a WiFi or other active wireless connection that eliminates the need for the remote to have a “line-of-sight visual” relationship to the screen to be able to control the system as is required for infrared TV remotes. In other words, the remote control 24 not only controls the interactive terminal 12 when it is not pointed at the screen, but also is capable of controlling the interactive terminal 12 from a different room. An exemplary remote control 24 is shown and described below with respect to FIG. 2.

At the centralized systems portion 14, the customer service resource 26 may be a computer or computer network operated by one or more customer service operators. The customer service resource 26 may be accessed by the interactive terminals 12 via a local area network or via the internet, for example. The customer service resource 26 may be located locally at the facility in which the interactive terminals 12 are located, or the customer service resource 26 may be located remotely in a facility dedicated to providing customer services for users of the interactive terminals 12. The customer service resource 26 may include voice and video communication capabilities, allowing the customer service operator to communicate with the users of the interactive terminals 12, healthcare professionals, and other third parties.

The customer service operators and/or authorized third parties (e.g., family members) may communicate with the interactive terminals 12 to provide to control the content and services provisioned at each of the interactive terminals 12. This schedule of provisioned content and services may be selected by the user of the interactive terminals 12, or by a third party who has been given authority to select the content and services available to the user. For example, the customer service operators may have automated access to all users with the ability, under predefined emergency or other conditions approved by the user, to override and activate the camera 20 that has been turned off by a user.

The customer service operator and/or authorized third parties may also have remote control of some or all services offered on the system. These remotely controlled services include but are not limited to: (1) activating or deactivating TV channels, (2) activating new video services purchased by the user, (3) downloading new video content for future viewing, (4) deleting video content from storage (e.g., in host 16 or server 28), (5) downloading new music content for storage, (6) deleting music content from storage, (7) remotely controlling the structure of storage for the music by creating music categories and moving stored music to new locations, (8) activating or deleting music channels from the MVPD provider or the Internet, (9) downloading new photos for storage, (10) deleting unwanted photos, (11) creating new photo albums and reorganize the storage of photos, (12) approving or deleting any third party's access to the user for the ability to send any form of information or to automatically connect via a video call, (13) e-mailing or otherwise electronically sending any software to approved user network members that need compatible software for the automated connections to the interactive terminal 12, (14) deleting any unwanted text or voice messages, (15) adding or deleting access to specific websites, (16) adding or deleting calendar or other message reminders that are provided on the display at appropriate times, and/or (17) adding or deleting any individuals, medical providers, community services, or commercial service providers for automated text, speaker phone or video phone connections.

The customer service operator may have access to the personal network of the user and user approved medical information that can be a resource in the event of an emergency or other condition where help from these third party resources would be of value. The customer service may also be provisioned as the first point of contact for an emergency call or it can be an automated secondary resource for any standard emergency (e.g., 911) call to other external emergency service providers.

The operator may also have access to a broad range of services and/or information resources that can be offered to the user. In this regard the customer service operator acts as a concierge for the user to help them find access to relevant information or services that they may not realize are available to meet their identified needs or interests. The operating system for the operator may provide simplified screens that automatically populate with the current structure and information for a user while also providing access to change the settings, content, or other controllable conditions that are present.

The operator may have non-stop access to a technical support team that has remote PC administrator control of the user's system using a secure VPN connection. The structure for the operator may provide for remote work locations that would allow an operator to work from home or a remote location with part time or full-time status.

The server 28 may be located in the same facility in which the interactive terminals 12 are located, or the server 28 may be located remotely. The server 28 may be accessed by the interactive terminals 12 via a local area network or via the internet, for example. The server 28 may store content available for access by all interactive terminals 12, such as movies, music, and games. The server 28 may also store data, information, and media specific to each of the users of the interactive terminals 12. For example, the server 28 may store a user's preferred or stored music or movie selection, photos and videos received by the user (e.g., via email), phone messages for the user, and/or messages and information from a doctor or other healthcare provider specific to the user. The server 28 may also store general menuing and user interface data and information for the interactive terminals 12.

FIG. 2 shows an embodiment of the remote control 24 suitable for use with the interactive terminals 12. The remote control 24 includes two volume (VOL) buttons 30 control the speaker volume for all hosted services that produce any audio through the speakers of the primary system. The remote control 24 also includes two channel (CH) buttons 32 that provide selection control of television channels. A single press of either button 32 moves the system up or down one channel. A longer hold of either button 32 creates a fast up or fast down changing of channel selection.

The four arrow buttons 34 in the middle of the remote are navigation buttons to move a cursor or the selection of an option presented on the screen to the active mode for use. If the active item on the screen is at the very top, bottom, left or right position on the screen, pushing the button to move it farther up, down, left or right produces no change on the screen.

The back button 36 moves the system back to the previous screen and related services that was presented for the user to have access to. If the user is at the default start screen, pushing the back button 36 does not provide a response.

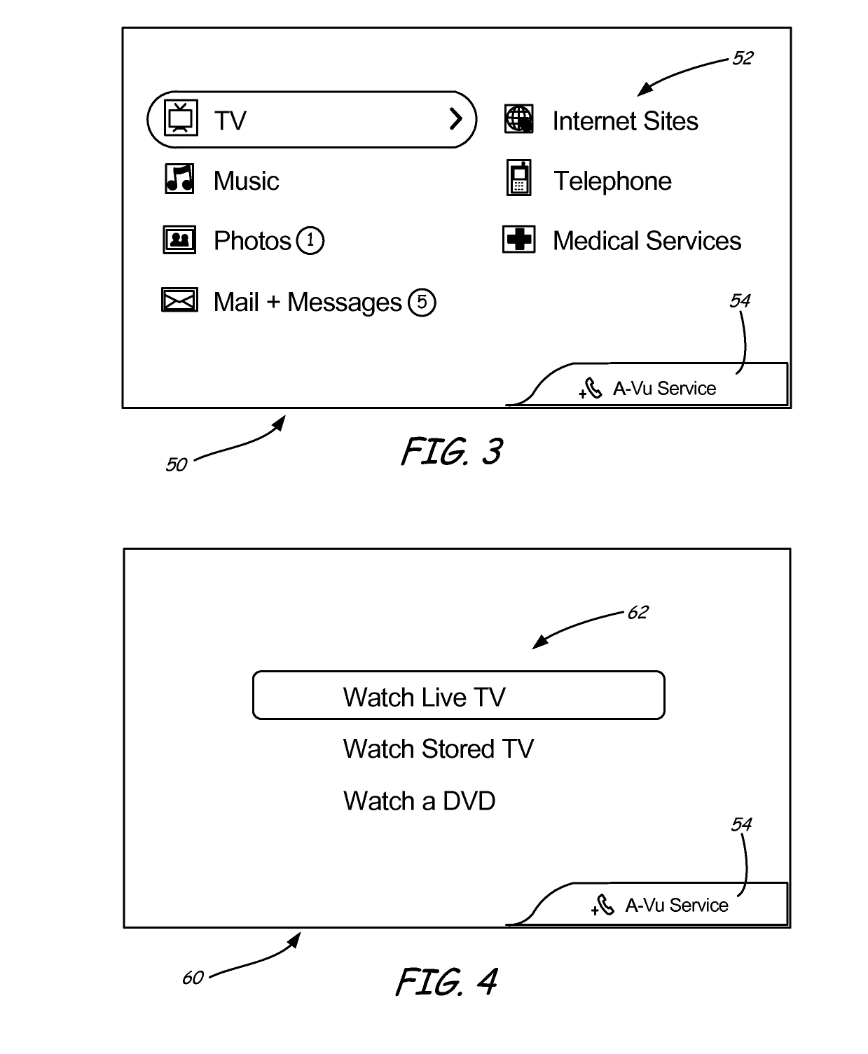

The enter button 38 activates the highlighted item as displayed on the current screen. For example, in FIG. 3 (discussed in more detail below), the TV option is highlighted on the screen, so pressing the enter button 38 would initiate the TV services provided through the interactive terminal 12.

The mute button 40 is active when the system has active audio. In some embodiments, pressing the mute button 40 the first time cuts the audio volume down to 50% of its current setting. Pressing the mute button 40 twice takes the system to full audio mute. Pressing the mute button 40 a third time restores the audio volume setting to its setting prior to pressing the mute button 40 the first time.

The restart button 42 can be pressed at any time to cause the system to return to the default start screen (FIG. 3) for access to services. In some embodiments, if the restart button 42 is pushed three consecutive times in a short time period (e.g., less than three seconds), or if the restart button 42 is held down for a longer period of time (e.g., 5-10 seconds or more), it also creates an automatic speaker phone call to the customer service center.

FIG. 3 is a screen view of a top level or primary screen 50 that provides access to provisioned services available on an interactive terminal 12 via a graphical user interface on the display 18. The screen view 50 of FIG. 3 shows one possible top level menu 52 of the provisioned primary services that may be offered to individual users. It will be appreciated that other menu configurations with other menu options are also possible. The screen view 50 presents a configuration of seven separate services plus direct access to customer service button 54 in the lower right corner. Access to customer service may be provided on all primary screen configurations.

The seven primary services presented in the menu 52 in FIG. 3 include TV, Music, Photos, Mail and Messages, Internet Sites, Telephone, and Medical Services. A common characteristic is that each of these services can be selected and accessed/activated using the remote control 24. If a service is highlighted on the menu 52, as the TV service on FIG. 3, the enter button 38 may be pressed to provide automatic access to that service. In some embodiments, selecting a primary service on the menu 52 links to a sublevel menu associated with the selected primary service. At least some of the options on the sublevel menu link directly to media content or a communication service.

The software associated with the interactive terminal 12 enables the addition or subtraction of specific services from the menu 52 and is capable of reordering the sequence of the services presented in the menu 52.

While not shown in FIG. 3, a portion or portions (e.g., windows) on the screen may also be provisioned for real-time temporary messages. For example, the bottom portion of the screen (e.g., next to the direct access customer service button 54) can be reserved for temporary banner types of messages that the system can be configured to display providing further temporary information for the end user.

FIG. 4 is a screen view of a TV service screen 60 including a menu 62 that is provided on the interactive terminal 12 for selecting from available television services on the system. This service provides access to live television programming via the “Watch Live TV” option or stored television programming and other stored media via the “Watch Stored TV” option. The screen 60 also provides access to play a DVD (located locally or remotely from the interactive terminal 12) via the “Watch a DVD” option.

Selecting the Watch Live TV option on the menu 62 provides access a standard line up of live TV channels or on-demand channels offered by an MVPD Video provider (e.g., cable, satellite, or internet). After the user has selected this service mode the interactive terminal 12 functions with standard TV channel selection and use. The package of TV channels and value added services are selectable by the end user. The system is also capable of deleting unwanted channels from the line-up of options that are seen by the end user.

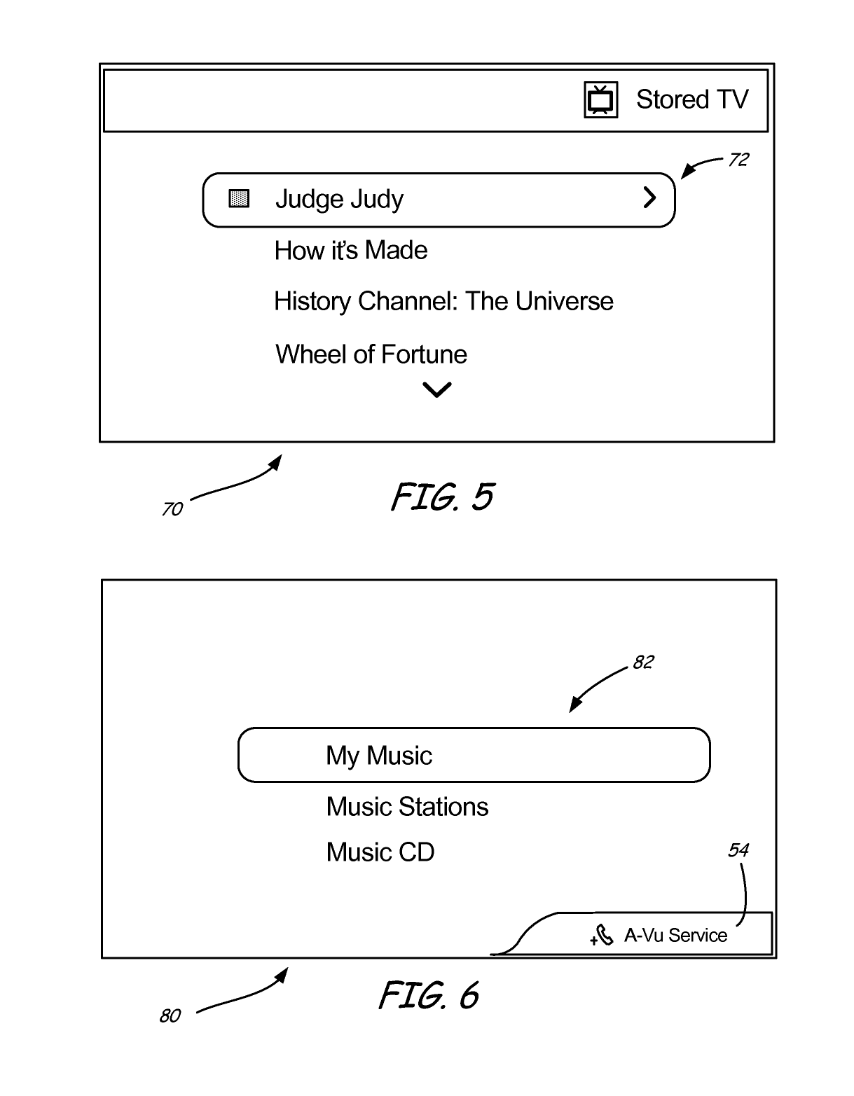

Selecting the Watch Stored TV option on the menu 62 provides access to a list of stored (i.e., recorded) video that is available to watch at any time the user chooses. A list of available titles, illustrated in stored TV screen 70 in FIG. 5, shows a menu 72 of some or all video material that is available. The screen 70 may include an intermediate menu that lists the categories of stored video available for viewing. In any case, the menu 72 includes video material that has been provisioned for recording and storage by the customer service center associated with the interactive terminal 12 that is recorded on a regular basis or as a non-recurring recording.

The video available on the menu 72 is electronically stored at either a local hard drive dedicated to the user's location (e.g., on host 16) or at the server 28 when appropriate. Stored video that is conditioned for automatic access can also be movies or other material that is downloaded from the internet by request of the user or sent to the user by approved members of the user's network. For example, a family member may order a movie from a video rental business or some other provider that automatically shows up in the list for viewing. Other third parties with permission may also send other video based material for education, exercise, or other purposes that also shows up for viewing on this primary list.

The selection of any listed video content on the menu 72 results in the automatic play of this content on the host 16. A screen may be displayed at the end of the video asking whether the user wants to store or delete the video content that has just been seen. A customer service operator has the ability to delete material as may be requested.

Selecting the Watch a DVD option on the menu 62 of screen 60 in FIG. 4 automatically activates the DVD player, which is also controlled by the remote control 24. If no DVD is detected in the player the user may be prompted to insert one and then the system moves forward to onscreen controls to start, pause, or stop the DVD. At the conclusion of the DVD, the DVD may be automatically ejected for the user to remove and store.

FIG. 6 illustrates the primary music service screen 80 including a menu 82, which appears when the Music option is selected from the menu 52 in FIG. 3. Activating this service provides access to three basic sources for music that plays through speakers associated with the interactive terminal 12 or speakers provided in the user's room. Selecting the “My Music” option provides an on screen listing of all electronically stored music. Highlighting and activating any specific title causes the media associated with the title to play on the system. The title may represent stored music or any other stored audio material, such as audio books, or other audio only material of any nature. Music that is available through the interactive terminal 12 could be entered locally on the system (i.e., on host 16), stored on server 28, or downloaded electronically from the internet. Either the customer service associated with the interactive terminal 12 or approved members of the user's network may have the ability to download music for storage.

Selecting the “Music Stations” option on menu 82 gives the user direct access to music stations provided by the MVPD or available over the internet. Internet music sites available through this option may be provisioned by customer service at the request of the user.

The system may also play a compact disc (CD) that has been inserted into a multimedia disc player associated with the host 16. If the user selects the “Music CD” option on the menu 82 and a CD is available on the player, the CD begins to play automatically. If the Music CD option is selected but a CD is not loaded into the player, the user may be prompted to insert a disc. The CD player is controlled through on-screen menus and interfaces navigated with the remote control 24. When the CD has finished playing, the host 16 may prompt the user whether he or she wants an electronic copy of the music on the CD to be stored on the system for future play (e.g., via the My Music option on screen 80).

The photos screen 90 shown in FIG. 5, which appears when the “Photos” option is selected from the menu 52 in FIG. 3, provides automatic access to photos stored on the system. The photos may be stored locally on the host 16, or remotely at a centralized systems portion 14/server 28 as described above. In any case, electronic photo albums may be configured by customer service. Digital photos may be provided from any type of media. For example, the multimedia disc player may have the capability to detect and upload photos to a new album from a CD, and the system may include a USB port for the uploading of stored material. Printed photos may be scanned or otherwise populated into the electronic photo albums with material. The user's approved network may also be given the ability to send photos via e-mail that are automatically accepted and stored for the user's viewing. The photo screen 90 includes a navigation bar 92 to scroll through the photos available for viewing.

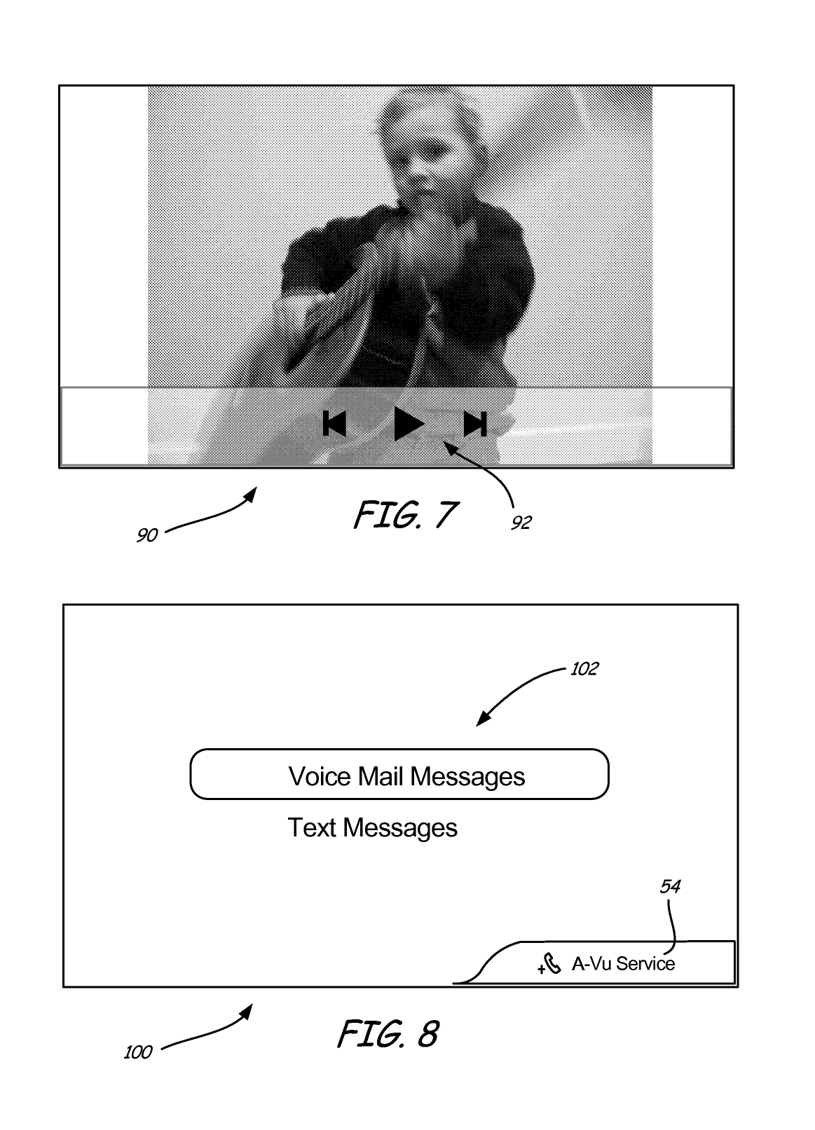

The “1” provided next to the Photos option in FIG. 3 indicates that the interactive terminal 12 has one new photo that has been received but not viewed. If the condition of “new photos” exists in the system and the user selects the Photos option on menu 52, the new photos may be automatically presented as the first option in the list of stored photo albums. If the user accesses the Photos section and no new photos are available, the user has access to all of the photo albums and related material available on the system for viewing. In any case, when the user activates this choice, the photo(s) are automatically displayed on the screen for viewing as illustrated in FIG. 7.

To accomplish this level of automation, the approved parties on the user's network may be provided software that is attached to the emails they send to the user's e-mail address that automatically strips the photo from the e-mail and routes it to the appropriate electronic photo album for storage and automated access. The user's software then sends a notation on the primary screen 30 informing the user of the availability of new photos to view. This automation can also be applied to new photo material that is associated with the user from other sources, such as social networking websites, photo sharing websites, and the like.

The Mail and Messages option on menu 52 in FIG. 3 provides automated access to voice and text messages from multiple resources including standard voice mail from the phone system, text messages from a mobile phone system, text messages from e-mail, or messages from social networking sites. The “5” next to the Mail and Messages option indicates that there are five new messages that have not been viewed or listened to by the user.

The mail and messages screen 100 shown in FIG. 8 is displayed when the user selects the Mail and Messages option in menu 52. This screen 100 includes a menu 102 that divides the user's message box into Voice Mail Messages and Text Messages. The number next to each of these options indicates the number of messages of each type waiting for the user to process.

When the Voice Mail Messages option is selected from the menu 102, the system provides direct access to a list of Voice Mail Messages stored on the system. New or unprocessed messages may be provided at the top of the list. When retrieved, the message is played through the primary speakers of the interactive terminal 12. At the end of processing any message the user may have the option to store or delete the message.

Text messages are processed in the same way that voice mail messages are processed when the Text Messages option is selected from the menu 102. The user may have the option of different size and styles of font that can be provisioned by customer service. Text messages that do not fit on one screen may be accessed by using the two middle navigation buttons 34 on the remote control 24 to scroll up or down on the text.

Text and/or voice mail messages may be date and time stamped, and may also be identified by sender. When a new message is received, the user may have the option to have a temporary message appear on the screen providing the sender's name and type of message received. This message can appear regardless of what other functions or services are active on the screen. Received messages may be processed as either voice or text messages or both. Voice to text and text to voice software options may be offered as part of the service package.

Voice and/or text messages may be responded to via speaker phone response. If the recorded response is in reply to a text message, it may be converted to a text response. In some embodiments, if the user is responding to a text message, the text of the converted voice response may be displayed on the screen for verification before sending.

Higher functioning users may be given the option of a simplified wireless keyboard that can support text responses to messages. A text message created in this manner can also be converted to a voice message response.

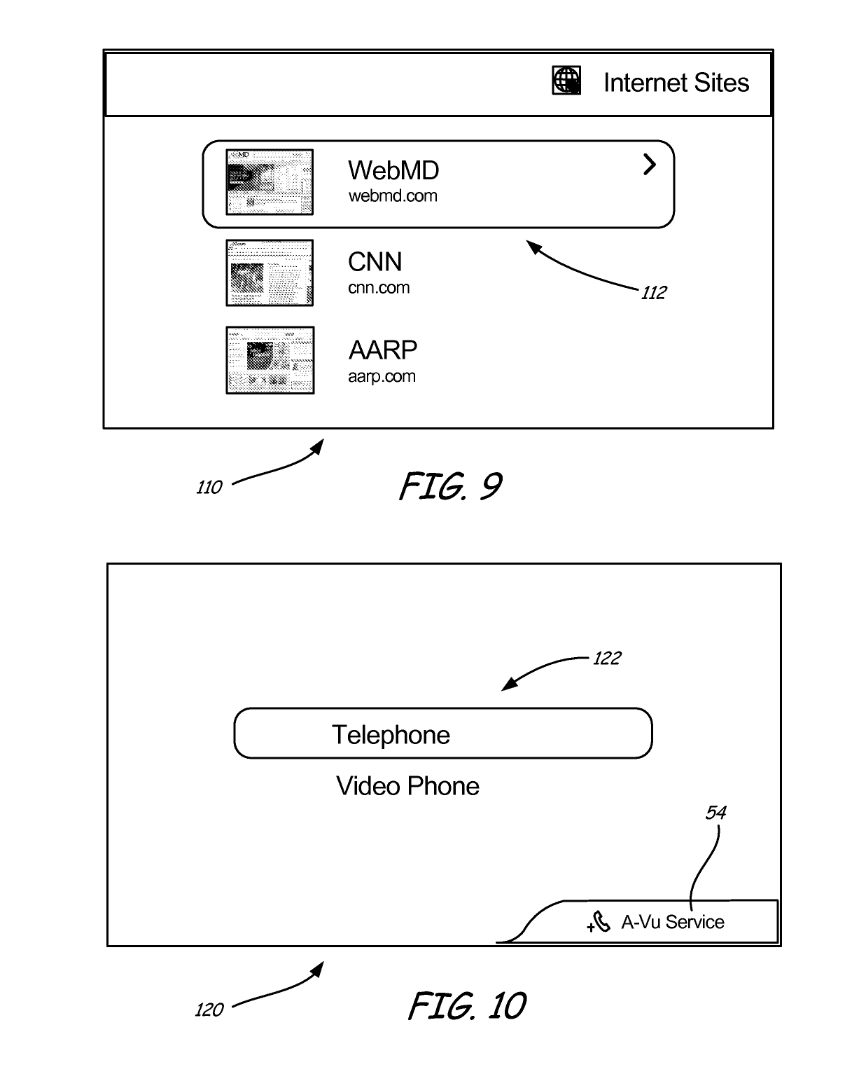

The Internet Sites option on menu 52 in FIG. 3 provides direct access to internet sites that have been approved and provisioned for the user. When a user selects the Internet Sites option, the screen 110 displays a menu 112 including a list of approved Internet sites for the user, as shown in FIG. 9. User access to the internet or internet based resources access to the user may be controlled by customer service. In some embodiments, there is no access to the user's address unless there is specific permission to have access and the user is not permitted to do open access Internet searches. This secure controlled structure is sometimes referred to as a “Walled Garden” structure.

The Telephone service screen 120, which includes a menu 122 and is displayed when the Telephone option is selected on menu 52 in FIG. 3, provides access to either automated speaker phone or video phone connections, as shown in FIG. 10. Speaker phone connections may be preprogrammed for automated access. Description of the available connection may be done with text and numbers shown on the display 18. A photo associated with the party talking to the user may also be displayed on the display 18. Speaker phone service may be provided through system speakers and a microphone associated with the interactive terminal 12, or it may be provided through the telephone 22.

If a user accepts a speaker phone call while other services are active, the audio for the other service may be automatically muted. The system may be configured to pause the other service for the duration of the speaker phone call. For example, the digital video recording functions of the system may be used to pause the programming when viewing live or broadcast video.

The video phone option may also have pre-programmed connections that have been provisioned by customer service. That is, the system may be programmed to accept video phone calls from only approved parties. The listing of provisioned video phone calls may also include both text and photos of the connection that is available. If a user accepts a video phone call while other services are playing, the audio for the other service is automatically muted and the screen image shifts to the video call for the full screen or display the video conference call in a window on the screen in front of the pre-existing screen material. The system may be configured to pause the other service for the duration of the video phone call. For example, the digital video recording functions of the system may be used to pause the programming when viewing live or broadcast video.

If the user or an approved third party tries to initiate a video call and the connection is not available, the system defaults to processing a voice mail message for receipt by either the user or a member of the user's approved video call network.

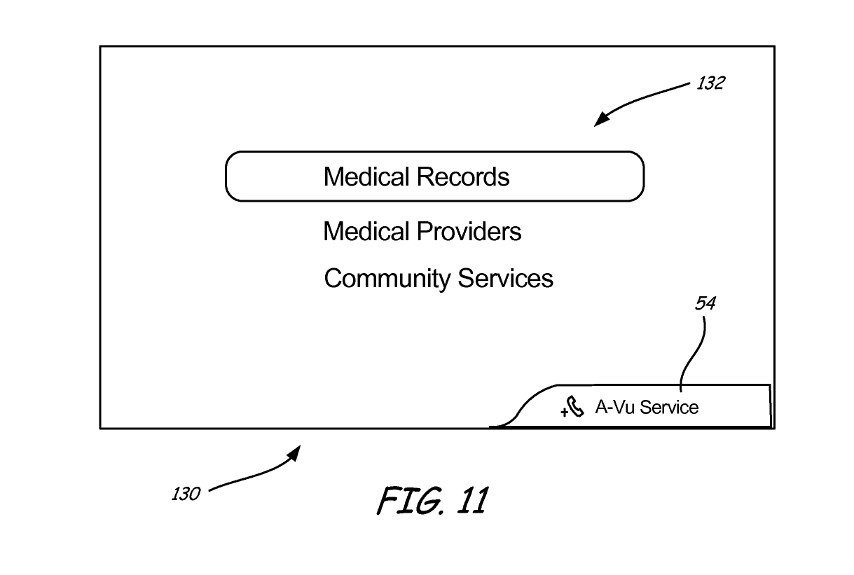

The Medical Services screen 130 in FIG. 11 is provided on the display 18 when the Medical Services option is selected from menu 52 in FIG. 1. The Medical Services screen 130, which includes a menu 132 functions as a portal for the user to have automated access to a variety of medical services, community services, or other professional caregiver resources. Connections to the services, organizations, or individuals through the Medical Services screen 130 can be via text, speaker phone, or video phone. Any connection through this set of accessible services is provided with a VPN connection so that these services are secure and compliant to any HIPAA or other medical service requirements. Any connection through this service portal is also available for electronic recording for liability or billing requirements.

Websites and the communication infrastructure for the connected services may be upgraded to be compliant with the platform associated with the interactive terminal 12 and the remote control 24 that may be used by the user to access information, people, or services offered by the third party they are connecting with. Connected third parties may also be given approved access to connect with the user for a live connection or to send information that they want the user to have access to. Access to the user's medical records may be PHR and EMR agnostic.

The system may host a pre-conditioned wireless connection (WiFi and other) that can be used to host medical and non-medical devices that caretakers or health care providers wish to activate in the residence of the user. Medical monitoring or other devices are approved for compatibility so that they automatically register and start to function when they are brought into range of the system they are registered to operate on.

The system has a controlled security structure that complies with HIPAA Security Rules. For example, a fingerprint scanner may be used as the final security confirmation before granting access to controlled medical information.

### Healthcare Facility Applications

The system described has value and operating characteristics when implemented as an internal system for the operations of a hospital or other healthcare facility. The system in the hospital or clinic operations can be accomplished with a central server model or with the use of the same distributed model used for private residences.

Patients may be interviewed at admission to determine what outside connections they would want to have available to them from their rooms. This connection and desired entertainment information may then be programmed for the specific room they are assigned to. A customer service agent dedicated to the healthcare facility or a third party customer service representative may then, as needed, contact the listed external contacts to confirm or provision the connections that they want to have during the hospital stay of the admitted patient. Approved network contacts of the patient would be able to send all of the information or services to this patient location that they would be able to do to a private residence location. If the patient is already a user of the system at their residential location, the profile of their home system can be ported to their location in the hospital.

The location and profile of each patient is also available to all staff operating locations. A summary list of patients provides access to that patient via phone, speaker phone, or video conference connection. This structure supports automated electronic access to each patient for doctors, nurses, or other staff that are at a location with a system that supports their access.

Each patient interaction within the healthcare system may be automatically recorded for patient care, billing and liability issues. This recording and other event information may be available for automated updates to the healthcare Electronic Medical Record (EMR) system.

The interactive terminal 12 in the patient room may be controlled by the same structure as the remote control 24 that is used in other operating environments. However, the healthcare environment may also have the option of a wired remote that also has the speaker built into the remote control 24 to create more localized audio.

The nurse or other staff may also use the system and its automated connections to create contact with the patient's outside network or external medical resources.

The video phone connection may be capable of video conference calls with multiple parties at the same time.

The video capabilities of the system provide opportunities for the delivery of education, training, therapy, or exercise video or audio material recommended or required by the healthcare network. A broadband accessible library of video and audio material may be developed and stored for the benefit of the patient as part of the healthcare operation. Video or audio material can be viewed by individual patients on their own schedule and not be limited to a broadcast schedule as is typical on a hospital television system. The video or audio access list of the patient can be populated by customer service to provide automatic access to the recommended material. The system can verify and document the patient use of the required or suggested video or audio material. Video or audio material can also be made available to a patient that has access to an interactive terminal 12 at home.

### Disabled Housing Management Applications

The system as described may also be used to provide utilities and value for organizations that manage disabled persons or other high need populations. For example, housing and service management organizations can operate remotely at times with reduced on-site staff in order to reduce cost and expand private independent living. Remote housing operations have the ability to add security sensors and monitors associated with the interactive terminal 12 to meet the unique residential monitoring needs of their operations and have those added features hosted on the system structure. Housing management staff may be given full remote access to and control of housing applied systems as needed. Their notification and access may be given priority over the customer service operator. This control can include but not be limited to: (1) security cameras, (2) speaker phone systems, (3) video phone connections, (4) door locks, (5) smoke detectors and other alarm systems, (6) medical sensor data, and (7) lifestyle sensor data.

Housing management may also have the option of providing some central services for their customers. These services could include but not limited to automated printing services for text or photos that are not located in the residence of their customers or managed by them.

### Senior Housing Management Applications

Senior housing organizations can range from the management of individual residences, independent living communities, assisted living communities, and nursing homes. Each of these resident environments can provide the personal benefits of the system described to residents and provide different levels of remote residential management and control for the organizations or individuals providing services. The list of implemented services may change depending on the location and availability of support staff and the level of security and monitoring that is desired. One benefit of the system structure described is the ability to extend the time that each resident can have at each level of care.

The nursing home model may be similar to the healthcare application model described above, while the assisted living model may be a combination of the healthcare model and the disabled residential management profile described above. Services to independent living locations may be similar to the remote disabled residential profile.

The system structure described may be used to facilitate the further growth of a caretaker industry where either non-professional (volunteer) or professional (fee based) caretakers provide services for users leveraging the structure of the managed system to provide services to the independent user. These services may include, but are not limited to, (1) private medical and non-medical on-site monitoring, (2) care management, (3) personal buying services, (4) residential maintenance, (5) security, and (6) other applications or utilities.

Since the described system is an application layer that is network agnostic, a user can take the interactive terminal 12 with them to a new or temporary location where it can be hosted on the available broadband network. This means that if a user moves to a new residential location they can take the interactive terminal 12 (or portions thereof) with them. It also means that if they own multiple residences that they can have full access to their system and services at any location that has adequate broadband service.

In some embodiments, the system includes the use of voice activated system commands where needed and applicable as an alternative to or in addition to the use of the remote control 24. Voice commands may be available for various actions including, but not limited to, (1) turning the speaker phone on and answering a call or dialing a connection, (2) making an emergency call, (3) turning the video camera 20 on or off, (4) returning the host 16 to the primary screen, and (5) calling customer service.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A method for providing media content and communication services to a user, the method comprising:
receiving a schedule of media content and communication services provisioned for the user;
generating an interactive menu including selectable options for each of the provisioned media content and communication services;
storing the interactive menu in a host device associated with the user;
displaying the interactive menu on a display connected to the host device;
receiving input signals at the host device from a remote control, wherein the input signals correspond to selections of the selectable options on the interactive menu; and
initiating the media content or communication service associated with an option on the interactive menu selected with the remote control.

2. The method of claim 1, wherein receiving the schedule of media content and communication services provisioned for the user comprises controlling the provisioned media content and communication services at a customer service resource or by an approved third party.

3. The method of claim 1, and further comprising:
providing an interface to allow a customer service resource or approved third party to modify the media content and communication services provisioned for the user;
generating an updated interactive menu including selectable options for each of the modified media content and communication services provisioned for the user; and
storing the interactive menu in a host device associated with the user.

4. The method of claim 1, wherein the generating step comprises generating a menu hierarchy including a top level menu that presents primary categories of media content and communication services and a plurality of sublevel menus that are linked to the top level menu.

5. The method of claim 4, wherein at least some of the selectable options on the plurality of sublevel menus initiate media content or a communication service.

6. The method of claim 1, wherein at least some of the provisioned media content is stored remotely from the host in a server.

7. The method of claim 1, wherein interactive terminal includes a video camera, and wherein the method further comprises:
activating the video camera remotely to observe the user's condition or communicate with the user.

8. The method of claim 1, wherein the displaying step comprises:
displaying an indication adjacent to one or more of the selectable options on the interactive menu indicating that new content or a new message is available.

9. A system for providing media content and communication services to users, the system comprising:
one or more interactive terminals each including a host device, a display, and a remote control, each interactive terminal associated with a user;
a centralized systems portion in communication with each host device of the one or more interactive terminals, wherein the centralized systems portion receives a schedule of media content and communication services provisioned for each user and generates an interactive menu specific to the user including selectable options for each of the provisioned media content and communication services, wherein the centralized systems portion provides the interactive menu specific to the user to the host device of the interactive terminal associated with the user,
wherein the remote control generates input signals to the host device that correspond to selections of the selectable options on the interactive menu, and wherein the host initiates the media content or communication service associated with an option on the interactive menu selected with the remote control.

10. The system of claim 9, wherein the centralized systems portion includes a customer service resource that receives the schedule of media content and communication services provisioned for the user and controls the provisioned media content and communication services at the host based upon the schedule.

11. The system of claim 9, wherein the interactive menu comprises a menu hierarchy including a top level menu that presents primary categories of media content and communication services available to the user and a plurality of sublevel menus that are linked to the top level menu, wherein at least some of the selectable options on the plurality of sublevel menus initiate media content or a communication service.

12. The system of claim 11, wherein the top level menu displays an indication adjacent to the selectable options on the top level menu when new content or a new message is available with respect to the selectable options.

13. The system of claim 9, wherein the schedule of media content and communication services provisioned for each user is selected and updatable by an approved third party.

14. The system of claim 9, wherein each interactive terminal further comprises a video camera, and wherein the video camera is remotely activatable from the centralized systems portion to observe the user's condition or communicate with the user.

15. An interactive terminal for providing media content and communication services to a user, the interactive terminal comprising:
a host device that stores an interactive menu generated from a schedule of media content and communication services provisioned for the user, the interactive menu displayable on a display associated with the host device and including selectable options for each of the provisioned media content and communication services; and
a remote control that generates input signals to the host, the input signals corresponding to selections of the selectable options on the interactive menu, wherein the host initiates the media content or communication service associated with an option on the interactive menu selected with the remote control.

16. The interactive terminal of claim 15, wherein the interactive menu is received from a customer service resource in communication with the host device.

17. The interactive terminal of claim 15, wherein the host device is in communication with a server that stores at least some of the provisioned media content selectable through the interactive menu.

18. The interactive terminal of claim 15, wherein the interactive menu comprises a menu hierarchy including a top level menu that presents primary categories of media content and communication services available to the user and a plurality of sublevel menus that are linked to the top level menu, wherein at least some of the selectable options on the plurality of sublevel menus initiate media content or a communication service.

19. The interactive terminal of claim 18, wherein the top level menu displays an indication adjacent to the selectable options on the top level menu when new content or a new message is available with respect to the selectable options.

20. The interactive terminal of claim 15, and further comprising:
a video camera that is remotely activatable to observe the user's condition or communicate with the user.

21. The interactive terminal of claim 15, and further comprising:
a telephone in communication with the host device, wherein the telephone is activatable via a button on the telephone or via a selectable option on the interactive menu.

22. The interactive terminal of claim 21, wherein the telephone uses voice over internet protocol (VoIP) for telephone calls when the telephone is within range of the host device, and wherein the telephone uses cellular communications for telephone calls when the telephone is out of range of the host device.

23. The interactive terminal of claim 22, wherein the telephone further includes global positioning system (GPS) location circuitry.
